(19) United States
(12) Patent Application Publication
(10) Pub. No.: US 2024/0430462 A1
(43) Pub. Date: Dec. 26, 2024

(54) SYSTEM, METHOD, AND APPARATUS FOR TRANSMISSION OF PROXY VIDEO CLIPS FOR VIDEO PRODUCTION

(71) Applicant: FIRST MILE TECHNOLOGIES INC., Oakville (CA)

(72) Inventors: Brandon COOPER, Oakville (CA); Bahaa ZANTOUT, Oakville (CA)

(73) Assignee: FIRST MILE TECHNOLOGIES INC., Oakville (CA)

(21) Appl. No.: 18/755,450

(22) Filed: Jun. 26, 2024

Related U.S. Application Data
(60) Provisional application No. 63/523,346, filed on Jun. 26, 2023.

(51) Int. Cl. H04N 19/40; H04N 21/235; H04N 21/436

(52) U.S. Cl. CPC H04N 19/40; H04N 21/2353; H04N 21/43622

(57) ABSTRACT

The present disclosure relates to a system, method, and apparatus for transmission of proxy video clips for video processing which extracts metadata for an original high resolution video file for transmission together with a lower resolution proxy file to provide seamless remote video editing, even without the original high resolution video. In an embodiment, the present system, method, and apparatus executes a custom metadata extraction process for each video camera model, such that all essential metadata is extracted from the original video footage. The extracted metadata may include information such as frame rate, resolution, color space, codec, etc., and is formatted for transmission together with a lower resolution proxy file to a remote video editing and postproduction location.

### CROSS-REFERENCE TO RELATED APPLICATIONS

This application claims the benefit of U.S. Provisional Application No. 63/523,346 filed on Jun. 26, 2023, and entitled SYSTEM, METHOD, AND APPARATUS FOR TRANSMISSION OF PROXY VIDEO CLIPS FOR VIDEO PRODUCTION, the entirety of which is incorporated herein by reference.

### BACKGROUND

Video production is a complex and challenging process that involves many steps and factors. From planning and shooting to editing and distributing, video producers face various obstacles and difficulties along the way. Some of the common challenges include lack of time, budget, and content ideas. Video production requires a lot of resources and creativity, which are often limited or constrained by deadlines, costs, and market demands.

Another challenge is creating an effective video strategy and following a consistent workflow. Video production involves multiple stakeholders, tasks, and tools, which need to be aligned and coordinated to achieve the desired goals and quality.

Yet another challenge is adapting to new technologies and platforms that enable remote and virtual production. Video production is constantly evolving and changing with the emergence of new technologies and platforms that offer new possibilities and opportunities for remote and virtual collaboration, communication, and distribution. For example, as the quality of video resolution increases from 1080i/1080p, to 4K, 5K, and 8K, the amount of data that must be transferred for video production seems to be ever increasing. Furthermore, there are a range of video file formats to consider, including (H.264), ProRes, CinemaDMG, and HEVC (H.265).

Even with high transmission speeds on wide bandwidths, transmitting high resolution video is still challenging, particularly where the shooting location is geographically distant from the studio in which video production will take place, and the wireless cellular coverage is less than optimal.

To overcome these challenges, video producers need a solution that can simplify and streamline the video production process, especially the critical step of moving video content from the set to the postproduction. This step is often time-consuming, costly, and risky, as it involves transferring large amounts of data using physical media, hard drives, or cables. These methods are prone to errors, delays, or losses, which can compromise the quality and security of the video content.

Therefore, what is needed is an improved system, method, and apparatus for addressing limitations in the prior art, and for enabling the transmission of proxy video clips for video production which enables video to be edited quickly and efficiently to meet the requirements of many time-sensitive applications and environments.

### SUMMARY

There is disclosed a system, method, and apparatus for transmission of proxy video clips for video processing which extracts metadata for an original high resolution video file for transmission together with a lower resolution proxy file to provide seamless video editing even without the original high resolution video.

In an aspect, there is provided a system which provides an end-to-end solution with resilient, secure, and robust connectivity as its core, and which extracts metadata from a camera by utilizing a high bandwidth channel, such as a Wi-Fi channel or an Ethernet channel, provided on the video camera.

In an embodiment, a metadata extraction device can connect to production cameras via an accessory arm, and extract metadata from the video camera through a high-bandwidth communication port, such as a Wi-Fi channel or an Ethernet port accessible via a standard Ethernet jack or via USB (e.g. USB-C). Alternatively, the metadata extraction device may be implemented as a module which is built directly into a video camera, specifically for the purpose of extracting essential metadata for proxy video files.

Through the Wi-Fi channel or Ethernet port, the metadata extraction device establishes a data tunnel between the metadata extraction device and a motion picture camera. The metadata extraction device software engine creates a series of call and response commands, interacting with the camera's internal access protocol using the motion picture camera manufacturer's instructions. This may involve manufacturer specific protocol commands and communication methods which are stored into the metadata extraction device's non-volatile storage and memory. Any necessary drivers or software for a specific manufacturer device may also be stored in the non-volatile storage and memory of the metadata extraction device to be retrieved and executed as may be required.

In an embodiment, the present system, method, and apparatus executes a custom metadata extraction process for each video camera model, such that all essential metadata is extracted from the video camera and the original full resolution video footage. The extracted metadata may include information such as frame rate, resolution, color space, codec, etc.

In another embodiment, the custom metadata extraction is performed substantially in real-time, such that the custom metadata is saved separately to be resynchronized, and transmitted together with a proxy video file encoded at a lower resolution. The lower-resolution video file is of sufficient quality for video editing purposes, and preferably retains the same aspect ratio and timecode as the original video file. However, the proxy video file sizes are much more manageable for wireless transmission over existing connection and transmission options, such as over a cellular network. But as they contain all critical metadata from the original, the video editing performed on the lower-resolution proxy video file can be seamlessly applied to the original video file, or another proxy video file encoded at a higher-resolution, once they are available at the editing studio.

In another embodiment, the present system, method, and apparatus aggregates 4G LTE, 5G, STARLINK™, and traditional GEO satellite connectivity, and connects reliably no matter the project shooting location. If required, multiple parallel transmission channels may be used to have sufficient bandwidth for the transmission of the extracted metadata together with the proxy video file encoded at a lower resolution.

In another embodiment, based on the bandwidth achievable from a given location, the system, method, and apparatus can switch to a proxy video file encoded at an even lower resolution, as may be required for reliable transmission.

In another embodiment, the extracted metadata may be stored separately in a format which allows the metadata to be resynchronized with one of multiple proxy files at different resolutions, thus providing the best available video quality for time-sensitive video editing projects. Thus, if transmission conditions improve, video editing performed using a lower-resolution file may be applied to an interim higher-resolution video file which may not be the final resolution file.

In another embodiment, the present system, method, and apparatus is configurable for virtually any camera model, encoder type, and file destination. This platform agnostic feature allows the present system, method, and apparatus to be utilized across virtually any available video recording and production platform.

In another embodiment, the present system, method, and apparatus tracks file download progress in real time via a user interface view, and also tracks daily session counts and total files per project.

In another embodiment, the present system, method, and apparatus is compatible with major video camera manufacturers such as ARRI™, RED™, Sony™, Canon™, and Fujinon™, and with established video production software such as AVID™ Media Composer and Frame.io™.

In another embodiment, the present system, method, and apparatus is compatible with cloud storage such as Microsoft Azure™, Google Cloud™, Amazon S3™, Wasabi™, and LucidLink™.

In another embodiment, the present system, method, and apparatus is custom configurable for virtually any video camera, and virtually any storage destination whether local or remote.

In another embodiment, the present apparatus is attachable to production cameras via an adjustable arm, and extracts metadata from the camera using their Wi-Fi channel or Ethernet port. The apparatus is able to generate video proxies using the extracted metadata to enable a camera to cloud workflow, and deliver these videos from the set location to a remote postproduction studio. In an embodiment, this is done over multiple bonded cellular networks which provide faster and more reliable data transmission than a single network. In a preferred embodiment, the apparatus is agnostic to the video camera type and the cloud destination, and can send the videos to virtually any cloud platform, such as Azure™, S3™ or Frame.io™.

In another embodiment, the present system, method, and apparatus provides faster, and more secure, video delivery by reducing the time and risk involved in transferring video files from the location set to postproduction which is often very far away. By generating video proxies on the on-camera apparatus, and sending them over bonded cellular networks, the present system, method, and apparatus eliminates the need for physical media, hard drives, or cables. This also reduces the chances of data loss, theft, or file corruption.

In another embodiment, the present system, method, and apparatus provides lower storage costs by reducing the size of video files by generating video proxies that are much smaller in size than the original video files. This also significantly reduces the bandwidth and data usage for uploading and downloading the files.

Finally, in another embodiment, the present system, method, and apparatus provides flexibility and compatibility by allowing video producers to choose any cloud platform that suits their storage and video production needs and preferences.

In this respect, before explaining at least one embodiment of the invention in detail, it is to be understood that the invention is not limited in its application to the details of construction and to the arrangements of the components set forth in the following description or the examples provided therein or illustrated in the drawings. Therefore, it will be appreciated that a number of variants and modifications can be made without departing from the teachings of the disclosure as a whole. Therefore, the present apparatus, system, and method is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 shows a schematic diagram of a workflow in accordance with an illustrative embodiment.

FIG. 2 shows a detailed view of the processing module of FIG. 1 in accordance with an illustrative embodiment.

FIG. 3 shows a detailed view of the transmission module of FIG. 1 in accordance with an illustrative embodiment.

FIG. 4 shows a schematic block diagram of a computing device which may provide an operating platform for various embodiments.

In the drawings, embodiments are illustrated by way of example. It is to be expressly understood that the description and drawings are only for the purpose of illustration and as an aid to understanding and are not intended as describing the accurate performance and behavior of embodiments and a definition of the limits of the invention.

### DETAILED DESCRIPTION

As noted above, the present disclosure relates to a system, method, and apparatus for transmission of proxy video clips for video processing which extracts metadata for an original high resolution video file for transmission together with a lower resolution proxy file to provide seamless video editing even without the original high resolution video.

In an aspect, there is provided a system which provides an end-to-end solution with resilient, secure, and robust connectivity as its core, and which extracts metadata from a camera by utilizing a high bandwidth channel, such as a Wi-Fi channel or an Ethernet channel, provided on the video camera.

In an embodiment, a metadata extraction device can connect to production cameras via an accessory arm, and extract metadata from the video camera through a high-bandwidth communication port, such as a Wi-Fi channel or an Ethernet port accessible via a standard Ethernet jack or via USB (e.g. USB-C). Alternatively, the metadata extraction device may be implemented as a module which is built directly into a video camera, specifically for the purpose of extracting essential metadata for proxy video files.

Through the Wi-Fi channel or Ethernet port, the metadata extraction device establishes a data tunnel between the metadata extraction device and a motion picture camera. The metadata extraction device software engine creates a series of call and response commands, interacting with the camera's internal access protocol using the motion picture camera manufacturer's instructions. This may involve manufacturer specific protocol commands and communication methods which are stored into the metadata extraction device's non-volatile storage and memory. Any necessary drivers or software for a specific manufacturer device may also be stored in the non-volatile storage and memory of the metadata extraction device to be retrieved and executed as may be required.

In an embodiment, the present system, method, and apparatus executes a custom metadata extraction process for each video camera model, such that all essential metadata is extracted from the video camera and the original full resolution video footage. The extracted metadata may include information such as frame rate, resolution, color space, codec, etc.

In another embodiment, the custom metadata extraction is performed substantially in real-time, such that the custom metadata is saved separately to be resynchronized, and transmitted together with a proxy video file encoded at a lower resolution. The lower-resolution video file is of sufficient quality for video editing purposes, and preferably retains the same aspect ratio and timecode as the original video file. However, the proxy video file sizes are much more manageable for wireless transmission over existing connection and transmission options, such as over a cellular network. But as they contain all critical metadata from the original, the video editing performed on the lower-resolution proxy video file can be seamlessly applied to the original video file, or another proxy video file encoded at a higher-resolution, once they are available at the editing studio.

In another embodiment, the present system, method, and apparatus aggregates 4G LTE, 5G, STARLINK™, and traditional GEO satellite connectivity, and connects reliably no matter the project shooting location. If required, multiple parallel transmission channels may be used to have sufficient bandwidth for the transmission of the extracted metadata together with the proxy video file encoded at a lower resolution.

In another embodiment, based on the bandwidth achievable from a given location, the system, method, and apparatus can switch to a proxy video file encoded at an even lower resolution, as may be required for reliable transmission.

In another embodiment, the extracted metadata may be stored separately in a format which allows the metadata to be resynchronized with one of multiple proxy files at different resolutions, thus providing the best available video quality for time-sensitive video editing projects. Thus, if transmission conditions improve, video editing performed using a lower-resolution file may be applied to an interim higher-resolution video file which may not be the final resolution file.

In another embodiment, the present system, method, and apparatus is configurable for virtually any camera model, encoder type, and file destination. This platform agnostic feature allows the present system, method, and apparatus to be utilized across virtually any available video recording and production platform.

In another embodiment, the present system, method, and apparatus tracks file download progress in real time via a user interface view, and also tracks daily session counts and total files per project.

In another embodiment, the present system, method, and apparatus is compatible with major video camera manufacturers such as ARRI™, RED™, Sony™, Canon™, and Fujinon™, and with established video production software such as AVID™ Media Composer and Frame.io™.

In another embodiment, the present system, method, and apparatus is compatible with cloud storage such as Microsoft Azure™, Google Cloud™, Amazon S3™, Wasabi™, and LucidLink™.

In another embodiment, the present system, method, and apparatus is custom configurable for virtually any video camera, and virtually any storage destination whether local or remote.

In another embodiment, the present apparatus is attachable to production cameras via an adjustable arm, and extracts metadata from the camera using their Wi-Fi channel or Ethernet port. The apparatus is able to generate video proxies using the extracted metadata to enable a camera to cloud workflow, and deliver these videos from the set location to a remote postproduction studio. In an embodiment, this is done over multiple bonded cellular networks which provide faster and more reliable data transmission than a single network. In a preferred embodiment, the apparatus is agnostic to the video camera type and the cloud destination, and can send the videos to virtually any cloud platform, such as Azure™, S3™ or Frame.io™.

In another embodiment, the present system, method, and apparatus provides faster, and more secure, video delivery by reducing the time and risk involved in transferring video files from the location set to postproduction which is often very far away. By generating video proxies on the on-camera apparatus, and sending them over bonded cellular networks, the present system, method, and apparatus eliminates the need for physical media, hard drives, or cables. This also reduces the chances of data loss, theft, or file corruption.

In another embodiment, the present system, method, and apparatus provides lower storage costs by reducing the size of video files by generating video proxies that are much smaller in size than the original video files. This also significantly reduces the bandwidth and data usage for uploading and downloading the files.

Finally, in another embodiment, the present system, method, and apparatus provides flexibility and compatibility by allowing video producers to choose any cloud platform that suits their storage and video production needs and preferences.

Illustrative embodiments of the present system, method, and apparatus will now be described in more detail with reference to the drawings.

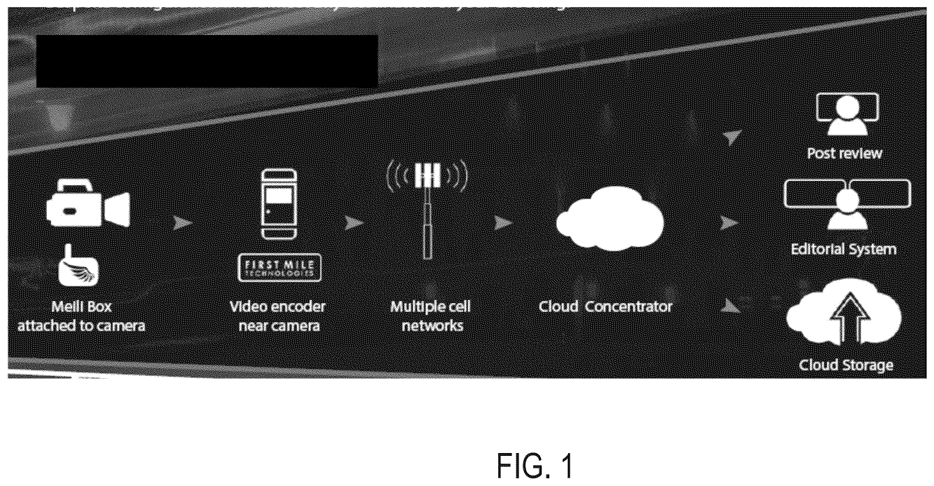

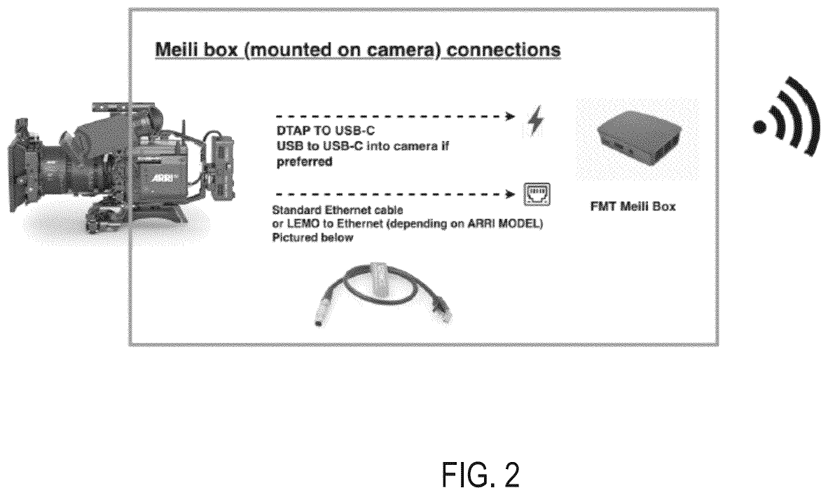

Now referring to FIG. 1, shown is a schematic diagram of a system, method and apparatus in accordance with an illustrative embodiment. As shown, the system includes a metadata extraction device which is attachable to a video camera. A more detailed view of the metadata extraction device is shown in FIG. 2.

The metadata extraction device can connect to production cameras via an accessory arm, and extract metadata from the video camera through a high-bandwidth communication port, such as a Wi-Fi channel or an Ethernet port accessible via a standard Ethernet jack or via USB (e.g. USB-C). Alternatively, the metadata extraction device may be implemented as a module which is built directly into a video camera, specifically for the purpose of extracting essential metadata for proxy video files.

Through the Wi-Fi channel or Ethernet port, the metadata extraction device establishes a data tunnel between the metadata extraction device and a motion picture camera. The metadata extraction device software engine creates a series of call and response commands, interacting with the camera's internal access protocol based on the motion picture camera manufacturer's instructions. This may involve manufacturer specific protocol commands and communication methods which are stored into the metadata extraction device's non-volatile storage and memory. Any necessary drivers or software for a specific manufacturer device may also be stored in the non-volatile storage and memory of the metadata extraction device to be retrieved and executed as may be required.

Once a data tunnel is established and a communication method is selected, the metadata extraction device initiates real-time extraction of metadata from the video camera in question. It is during these exchanges that a bi-directional information flow is established, sending camera state/status as well as pushed commands (i.e. record start/stop, remote setting control, amongst others) and the identification and exchange of selected camera and lens related metadata.

In an embodiment, the metadata extraction device software engine identifies targeted metadata fields, filters and extracts them from the camera via the Wi-Fi or Ethernet connection, passing them through the transmission module and then to a cloud destination of choice to be stored or utilized in various post-production processes via cloud based applications.

The extracted metadata includes information such as frame rate, resolution, color space, codec, etc. As each video camera may store metadata in a different format, the metadata extraction device includes a feature to identify the type of video camera it is connected to, and to extract metadata by running an extraction code specific for that particular video camera.

Through this extraction process, the metadata extraction device is able to extract a wide range of data, such as the metadata extracted from various cameras, as summarized below. It will be appreciated that this list is illustrative, and not a complete list of possible metadata that can be extracted.

### Metadata Supported Flags

### Base Metadata Presets:

a) Clip
b) Reel name
c) REC Start/Stop
d) Timecode In/Out
e) Start/Stop Flags
f) Clip File Name (As saved on camera)
g) Codec
h) Frame Rate
i) Audio Channels
j) Sensor Size
k) Aperture
l) Inclination
m) Duration
n) Focal length
o) Shutter speed
p) ASA/ISO Speed
q) GPS Location
r) Whitepoint
s) Tint
t) F-Stop/T-Stop
u) Sensor FPS
v) Lens Name
w) Look Name
x) Distance to Object/Lens height and tilt angle
y) Active ND Filters

### Color Metadata Presets:

a) Scene
b) Take
c) Camera
d) Circle/select
e) Color and framing information (on availability)
f) Chroma
g) Color Depth
h) Subsampling
i) Codec
j) Stereo audio mix
k) Hue
l) Baked in LUT
m) Contrast
n) Color Space: CMYK, RGB etc.
o) Pixel Dimensions
p) White Balance Parameters

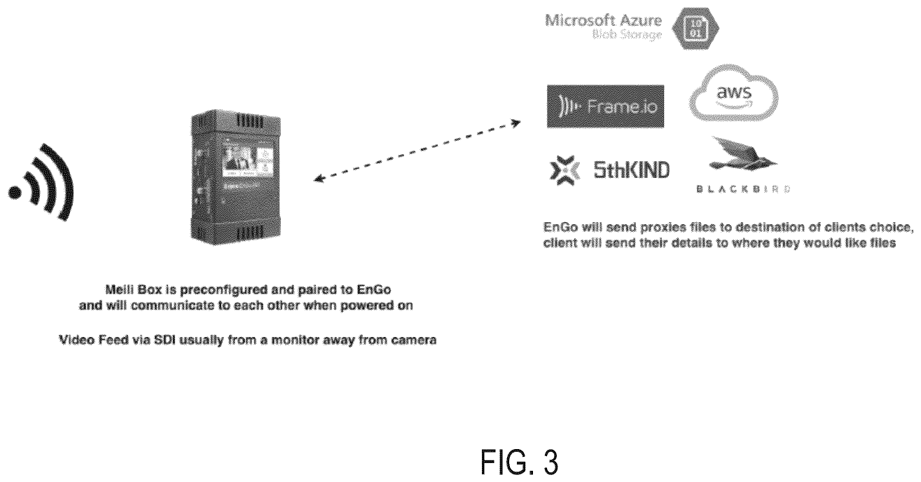

The metadata extracted from the video camera is formatted in a manner that allows all of the metadata to be efficiently transmitted with the video proxy files using a video encoder, such as the one shown in FIG. 3.

Video proxy files are lower-resolution versions of the original video files that retain the same aspect ratio and timecode. Video proxy files are useful for previewing, editing, and sharing video content quickly and efficiently, without compromising the quality of the original files.

The present system, method, and apparatus encodes and sends lower-resolution proxy files to a cloud destination, such as one of any number of cloud platforms illustrated in FIG. 3. Multiple parallel channels may be used to increase the available bandwidth for transmitting a video proxy file to cloud storage, and for post review and editing. For example, multiple bonded cellular channels may be used to achieve a higher bandwidth than would be available over a single 4G/5G channel. The bonded cellular channel achieves higher speed and reliability than each individual connection, and are ideal for transferring large amounts of data in areas where internet access is limited or unreliable.

The extracted metadata may be stored separately in a format which allows the metadata to be resynchronized with one of multiple proxy files at different resolutions, thus providing the best available video quality for time-sensitive video editing projects. Thus, if transmission conditions improve, video editing performed using a lower-resolution file may be applied to an interim higher-resolution video file which may not be the final resolution file.

In an embodiment, video camera metadata is compiled, translated into a text format, packaged in a J-Son file and sent via a bonded/encrypted cellular pathway to the cloud destination where it meets up with the associated MP4 video file that is created in the video encoder/cellular transmitter.

In an embodiment, the metadata extracted by the metadata extraction module is identical to that which is included in the original high resolution video file recorded in the video camera. Crucial metadata such as timecode values, start stop flags, file name, reel name shipped with the extracted metadata file is delivered to a remote video editor's editorial system together with the video proxy file to allow an editor to immediately begin editing the proxy video file, which edits can then be applied to the original high resolution video file that is received later at the studio for the final picture finishing stages. Furthermore, the extracted metadata is significantly more comprehensive than the metadata that can be typically accessed by an end user via an SDI port. The prior art metadata extraction method via the SDI port has a hard limit as to how much information passes via an SDI port, leaving crucial and expansive amounts of metadata behind. Advantageously, the present system, method, and apparatus is able to extract and create a comprehensive extracted metadata file that leaves nothing behind.

In an embodiment, the present system, method, and apparatus is able to extract and transmit metadata that is valuable to other postproduction processes, like color grading and manipulation via camera sensor settings and in-camera pre-made LUTs (look up tables) which assign specific looks to selected scenes in camera. The present system, method, and apparatus is also extracting and transmitting lens metadata such as focal length, focus and aperture settings, as well as camera positioning information, inclination, and angle of view that can be used in Visual FX applications, giving the remote studio early access to begin the often laborious work of Visual FX preparations early, instead of waiting for the original full resolution video files to be delivered to post production at least hours or perhaps many days after they are created on a remote set. These extracted metadata sets that are captured by the present metadata extraction device live on the shooting location are immediately sent wirelessly to the cloud receiving destination, and then synchronized with the associated proxy video files from the connected video encoder. From there, the extracted metadata file and the proxy video files are pushed to the postproduction application of the user's choice where they can begin editing, coloring or manipulating their video footage with the confidence that all of their edits can be applied to the original high resolution video files down the line. This process is almost instantaneous, enabling work of all kinds to begin in short succession of the creation on set.

The present system, method, and apparatus is agnostic to the cloud destination, and can send the video proxies to any cloud platform that supports file storage and sharing. Some examples of cloud platforms are Azure blob, S3 bucket or Frame.io. The cloud destination can be configured by the user using a web interface or an app on their smartphone or tablet. The user can also monitor the status of the transfer process and receive notifications when it is completed.

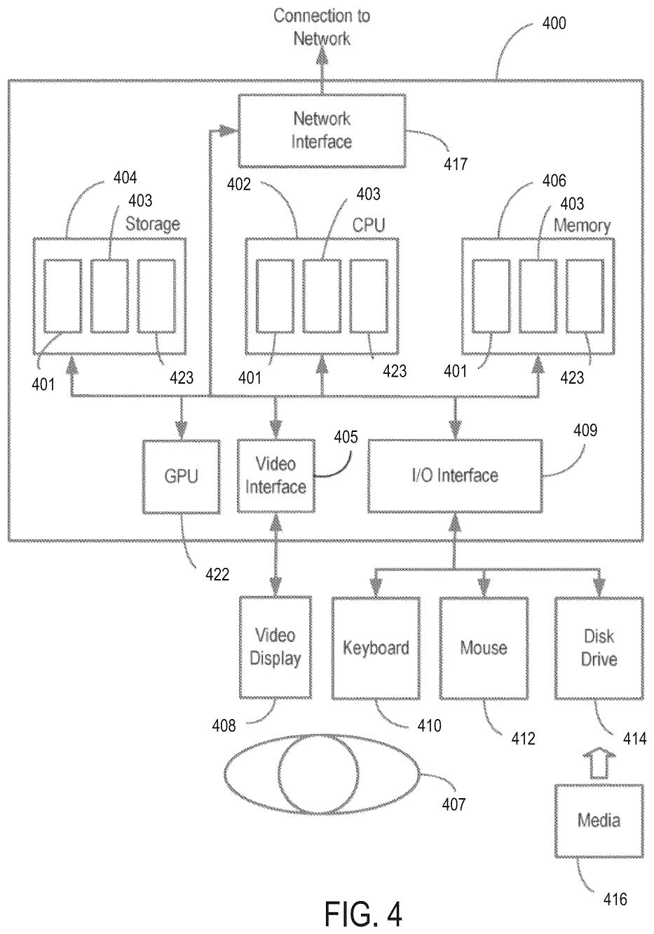

Now referring to FIG. 4 shown is a schematic block diagram of a generic computing device 400 that may provide a suitable operating environment in one or more embodiments. A suitably configured computer device, and associated communications networks, devices, software and firmware may provide a platform for enabling one or more embodiments as described above. By way of example, FIG. 4 shows a generic computer device 400 that may include a central processing unit (“CPU”) 402 connected to a storage unit 404 and to a random access memory 406. The CPU 402 may process an operating system 401, application program 403, and data 423. The operating system 401, application program 403, and data 423 may be stored in storage unit 404 and loaded into memory 406, as may be required. Computer device 400 may further include a graphics processing unit (GPU) 422 which is operatively connected to CPU 402 and to memory 406 to offload intensive calculations (including, but not limited to image processing or inference or training of deep learning AI models) from CPU 402 and run these calculations in parallel with CPU 402. An operator 410 may interact with the computer device 400 using a video display 408 connected by a video interface 405, and various input/output devices such as a keyboard 410, pointer 412, and storage 414 connected by an I/O interface 409. In known manner, the pointer 412 may be configured to control movement of a cursor or pointer icon in the video display 408, and to operate various graphical user interface (GUI) controls appearing in the video display 408. The computer device 400 may form part of a network via a network interface 411, allowing the computer device 400 to communicate with other suitably configured data processing systems or circuits. A non-transitory medium 416 may be used to store executable code embodying one or more embodiments of the present method on the generic computing device 400.

Advantageously, the present system, method, and apparatus simplifies and streamlines the video production process by enabling fast and secure video delivery from set to postproduction.

The present system, method, and apparatus extracts essential metadata from video cameras via a high bandwidth channel, such as a Wi-Fi channel or an Ethernet port, and encodes lower-resolution proxy files using the extracted metadata. The proxy files and extracted metadata are proxies on the device using metadata are transmitted remotely, for example over bonded cellular networks, to any cloud destination.

The present system, method and apparatus thus offers a number of benefits for video producers such as faster and more secure video delivery, lower storage costs, and greater flexibility and compatibility.

The present system, method, and apparatus can help video producers overcome some of the common challenges they face in their work and achieve their goals more efficiently and effectively, and transform the way video content is created and distributed in today's digital world.

Thus, in an aspect, there is disclosed a system for transmission of proxy video clips for video processing, comprising: a metadata extraction module for extracting video camera metadata for an original high resolution video file directly from a video camera via a high bandwidth channel; an encoder module for encoding a lower-resolution proxy video file corresponding to the extracted metadata; and a transmission module for wirelessly transmitting the lower-resolution proxy video file and the extracted metadata.

In an embodiment, the high bandwidth channel comprises one or more of a Wi-Fi channel and an Ethernet channel provided on the video camera.

In another embodiment, the metadata extraction module is adapted to establish a data tunnel between the metadata extraction module and the video camera via one or more of the Wi-Fi channel and the Ethernet channel.

In another embodiment, the metadata extraction module is configured to extract video camera metadata via the established data tunnel substantially in real-time.

In another embodiment, the metadata extraction module formats the extracted video camera metadata in an extracted metadata file that can be transmitted together with or independently of the lower-resolution proxy video file.

In another embodiment, the extracted metadata file includes video camera metadata normally inaccessible via conventional metadata extraction via an SDI port, thereby providing comprehensive video camera metadata which may assist a video editor when editing the lower-resolution proxy video file.

In another embodiment, the transmission module is adapted to transmit the extracted metadata file and the lower-resolution proxy video file via one or more wireless networks comprising one or more of 4G LTE, 5G, STARLINK™, and traditional GEO satellite connectivity.

In another aspect, there is provided a method for transmission of proxy video clips for video processing, comprising: extracting, utilizing a metadata extraction module, video camera metadata for an original high resolution video file directly from a video camera via a high bandwidth channel; encoding, utilizing an encoder module, a lower-resolution proxy video file corresponding to the extracted metadata; and wirelessly transmitting, utilizing a transmission module, the lower-resolution proxy video file and the extracted metadata.

In an embodiment, the high bandwidth channel comprises one or more of a Wi-Fi channel and an Ethernet channel provided on the video camera.

In another embodiment, the metadata extraction module is adapted to establish a data tunnel between the metadata extraction module and the video camera via one or more of the Wi-Fi channel and the Ethernet channel.

In another embodiment, the metadata extraction module is configured to extract video camera metadata via the established data tunnel substantially in real-time.

In another embodiment, the metadata extraction module formats the extracted video camera metadata in an extracted metadata file that can be transmitted together with or independently of the lower-resolution proxy video file.

In another embodiment, the extracted metadata file includes video camera metadata normally inaccessible via conventional metadata extraction via an SDI port, thereby providing comprehensive video camera metadata which may assist a video editor when editing the lower-resolution proxy video file.

In another embodiment, the transmission module is adapted to transmit the extracted metadata file and the lower-resolution proxy video file via one or more wireless networks comprising one or more of 4G LTE, 5G, STARLINK™, and traditional GEO satellite connectivity.

In yet another aspect, there is provided an apparatus for transmission of proxy video clips for video processing, comprising: a metadata extraction module for extracting video camera metadata for an original high resolution video file directly from a video camera via a high bandwidth channel; an encoder module for encoding a lower-resolution proxy video file corresponding to the extracted metadata; and a transmission module for wirelessly transmitting the lower-resolution proxy video file and the extracted metadata.

In an embodiment, the high bandwidth channel comprises one or more of a Wi-Fi channel and an Ethernet channel provided on the video camera.

In another embodiment, the metadata extraction module is adapted to establish a data tunnel between the metadata extraction module and the video camera via one or more of the Wi-Fi channel and the Ethernet channel.

In another embodiment, the metadata extraction module is configured to extract video camera metadata via the established data tunnel substantially in real-time.

In another embodiment, the metadata extraction module formats the extracted video camera metadata in an extracted metadata file that can be transmitted together with or independently of the lower-resolution proxy video file.

In another embodiment, the extracted metadata file includes video camera metadata normally inaccessible via conventional metadata extraction via an SDI port, thereby providing comprehensive video camera metadata which may assist a video editor when editing the lower-resolution proxy video file.

While various illustrative embodiments of the system, method, and apparatus have been described, it will be appreciated that various modifications and amendments may be made without departing from the scope of the invention.

1. A system for transmission of proxy video clips for video processing, comprising:
a metadata extraction module for extracting video camera metadata for an original high resolution video file directly from a video camera via a high bandwidth channel;
an encoder module for encoding a lower-resolution proxy video file corresponding to the extracted metadata; and
a transmission module for wirelessly transmitting the lower-resolution proxy video file and the extracted metadata.

2. The system of claim 1, wherein the high bandwidth channel comprises one or more of a Wi-Fi channel and an Ethernet channel provided on the video camera.

3. The system of claim 2, wherein the metadata extraction module is adapted to establish a data tunnel between the metadata extraction module and the video camera via one or more of the Wi-Fi channel and the Ethernet channel.

4. The system of claim 3, wherein the metadata extraction module is configured to extract video camera metadata via the established data tunnel substantially in real-time.

5. The system of claim 4, wherein the metadata extraction module formats the extracted video camera metadata in an extracted metadata file that can be transmitted together with or independently of the lower-resolution proxy video file.

6. The system of claim 5, wherein the extracted metadata file includes video camera metadata normally inaccessible via conventional metadata extraction via an SDI port, thereby providing comprehensive video camera metadata which may assist a video editor when editing the lower-resolution proxy video file.

7. The system of claim 6, wherein the transmission module is adapted to transmit the extracted metadata file and the lower-resolution proxy video file via one or more wireless networks comprising one or more of 4G LTE, 5G, STARLINK™, and traditional GEO satellite connectivity.

8. A method for transmission of proxy video clips for video processing, comprising:
extracting, utilizing a metadata extraction module, video camera metadata for an original high resolution video file directly from a video camera via a high bandwidth channel;
encoding, utilizing an encoder module, a lower-resolution proxy video file corresponding to the extracted metadata; and
wirelessly transmitting, utilizing a transmission module, the lower-resolution proxy video file and the extracted metadata.

9. The method of claim 8, wherein the high bandwidth channel comprises one or more of a Wi-Fi channel and an Ethernet channel provided on the video camera.

10. The method of claim 9, wherein the metadata extraction module is adapted to establish a data tunnel between the metadata extraction module and the video camera via one or more of the Wi-Fi channel and the Ethernet channel.

11. The method of claim 10, wherein the metadata extraction module is configured to extract video camera metadata via the established data tunnel substantially in real-time.

12. The method of claim 11, wherein the metadata extraction module formats the extracted video camera metadata in an extracted metadata file that can be transmitted together with or independently of the lower-resolution proxy video file.

13. The method of claim 12, wherein the extracted metadata file includes video camera metadata normally inaccessible via conventional metadata extraction via an SDI port, thereby providing comprehensive video camera metadata which may assist a video editor when editing the lower-resolution proxy video file.

14. The method of claim 13, wherein the transmission module is adapted to transmit the extracted metadata file and the lower-resolution proxy video file via one or more wireless networks comprising one or more of 4G LTE, 5G, STARLINK™, and traditional GEO satellite connectivity.

15. An apparatus for transmission of proxy video clips for video processing, comprising:
a metadata extraction module for extracting video camera metadata for an original high resolution video file directly from a video camera via a high bandwidth channel;
an encoder module for encoding a lower-resolution proxy video file corresponding to the extracted metadata; and
a transmission module for wirelessly transmitting the lower-resolution proxy video file and the extracted metadata.

16. The apparatus of claim 15, wherein the high bandwidth channel comprises one or more of a Wi-Fi channel and an Ethernet channel provided on the video camera.

17. The apparatus of claim 16, wherein the metadata extraction module is adapted to establish a data tunnel between the metadata extraction module and the video camera via one or more of the Wi-Fi channel and the Ethernet channel.

18. The apparatus of claim 17, wherein the metadata extraction module is configured to extract video camera metadata via the established data tunnel substantially in real-time.

19. The apparatus of claim 18, wherein the metadata extraction module formats the extracted video camera metadata in an extracted metadata file that can be transmitted together with or independently of the lower-resolution proxy video file.

20. The apparatus of claim 19, wherein the extracted metadata file includes video camera metadata normally inaccessible via conventional metadata extraction via an SDI port, thereby providing comprehensive video camera metadata which may assist a video editor when editing the lower-resolution proxy video file.
